(19) United States
(12) Patent Application Publication
(10) Pub. No.: US 2025/0270830 A1
(43) Pub. Date: Aug. 28, 2025

(54) ADJUSTMENT OF A SPATIAL POSITION OF A MATERIAL DEPOSITION DEVICE ALIGNED TO DEPOSIT A STRUCTURAL MATERIAL AT A TARGET POINT OF DEPOSITION

(71) Applicant: ICON Technology, Inc., Austin, TX (US)

(72) Inventors: Evan Jensen, Buda, TX (US); Alexander Le Roux, Austin, TX (US); Jonathan Ladouceur, Austin, TX (US)

(73) Assignee: ICON Technology, Inc., Austin, TX (US)

(21) Appl. No.: 18/586,032

(22) Filed: Feb. 23, 2024

(51) Int. Cl. E04G 21/04; B33Y 10/00; B33Y 50/02

(52) U.S. Cl. CPC E04G 21/0463; E04G 21/0436; B33Y 10/00; B33Y 50/02

(57) ABSTRACT

Various embodiments relate generally to manufacturing construction techniques to form structures with embodiments including computer software and systems, and control systems, and, more specifically, to a computing and a mechanical platform configured to receive a material with which to form a structure of programmable dimensions and deposit the material at a stabilization platform operating at a frame of reference independent (or nearly independent) relative to a base delivery system, whereby data representing the frame of reference is based on sensor data identifying a position and spatial alignment with a targeted point of deposition of the material.

### FIELD

Various embodiments relate generally to additive manufacturing and construction techniques to form structures with embodiments including computer software and systems, and control systems, and, more specifically, to a computing and a mechanical platform configured to receive a material with which to form a structure of programmable dimensions and deposit the material at a stabilization platform operating at a frame of reference independent (or nearly independent) relative to a base delivery system, whereby data representing the frame of reference is based on sensor data identifying a position and spatial alignment with a targeted point of deposition of the material.

### BACKGROUND

Advances in robotics, computing hardware, and software has contributed to various improvements to provide materials for construction of any type of structure such as a wall by extruding one or more viscous materials as a “bead” or longitudinally formed material. In some cases, materials may be deposited as three-dimensional (“3D”) printed structures.

In some cases, typical construction techniques have been directed to employ one or more viscous materials to form structures limited to dimensions that form single story structures or buildings. Known mechanisms and processes for forming longitudinally constructed structures have been affected by various environments factors, such as wind, temperature, atmospheric conditions (e.g., humidity), or any force causing displacement of the placement of a material. Hence, typical mechanisms and processes tend to produce structures less successfully that conform to architectural design definitions and specifications. Thus, typical imperfections arising in a structure produced by conventional techniques, especially structures having dimensions consistent with multiple stories, usually require physical, technical, and financial expenditures of resources to ensure corrections or repairs.

Thus, what is needed is a solution to convey and deposit materials to form one or more structures of various vertical or horizontal dimensions, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting a system including a stabilization platform configured to stabilize a nozzle unit configured to deposit a material to form a structure, according to some embodiments;

FIGS. 2 and 3 depict examples of systems implementing a stabilization platform coupled via linkage members to a base delivery unit, according to some examples;

FIG. 4 is a diagram depicting another example of a stabilization platform and a nozzle unit of a material deposition device that implements one or more arrays of sensors, according to some examples;

FIG. 5 depicts an example flow with which to deposit material using a material deposition device, according to some examples;

FIG. 6 depicts an example of a portion of a material deposition device, according to some embodiments;

FIG. 7 is a diagram depicting an example of a portion of a material deposition device including a nozzle unit, according to some implementations;

FIG. 8 depicts an example flow with which to deposit material by adjusting a nozzle unit, according to some examples;

FIG. 9 illustrates an exemplary application architecture for temporal position detection and adjustment control for a nozzle unit to deposit or extrude one or more materials to manufacture a structure, according to some examples; and

FIG. 10 illustrates examples of various computing platforms configured to provide various functionalities to components of a computing platform configured to provide functionalities described herein.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in any arbitrary order, unless otherwise provided in the claims.

A detailed description of one or more examples is provided below along with accompanying figures. The detailed description is provided in connection with examples and is not limited to any particular example. The scope is limited only by the claims, and numerous alternatives, modifications, and equivalents thereof. Numerous specific details are set forth in the following description to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

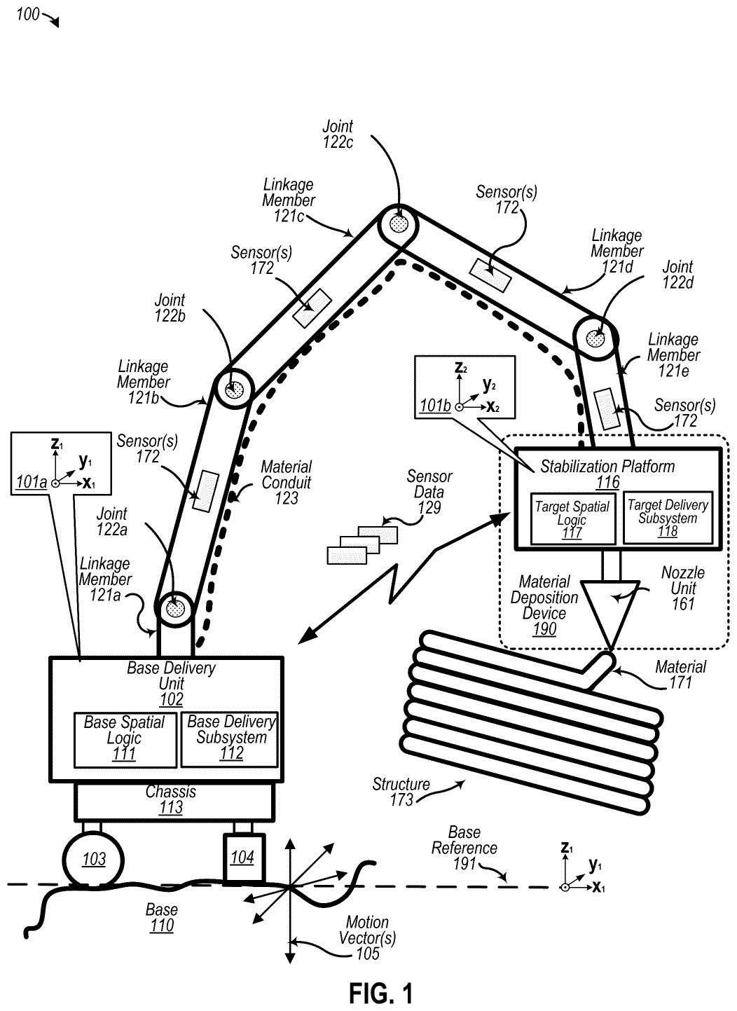

FIG. 1 is a diagram depicting a system including a stabilization platform configured to stabilize a nozzle unit configured to deposit a material to form a structure, according to some embodiments. Diagram 100 depicts an example of a stabilization platform 116 including a nozzle unit 161 configured to deposit a material 171 to form structure 173, such as one or more walls, floors, footings, foundations (e.g., slabs), basements, swimming pools, etc. at any number of stories or dimensions independently or substantially independently relative to a base delivery unit 102 and a grade elevation or physical features of base 110. In some cases, stabilization platform 116 including nozzle unit 161 may be implemented as a material deposition device 190 configured to deposit a material. Examples of material deposition device 190 may include a 3D printer tool or printer head configured to form structure 173 in accordance with data defining one or more spatial dimensions including forming structures of multiple stories. Spatial dimensions may be based on a data file expressing formation of structure 173 in cartesian coordinates and as a function of time (e.g., in accordance with an architectural specification). In some examples, depositing a material (or deposition thereof) may include applying, discharging, extruding, pumping out, etc., material 171 via nozzle unit 161.

Material deposition device 190 may be configured to operate at a first frame of reference 101b isolated (or substantially isolated) from a second frame of reference 101a at which base delivery unit 102 may be configured to operate, whereby a frame of reference may be described in terms of data representing a spatial position as one or more subsets of points to identify kinematic motion and position relative to one or more other objects or bodies. For example, material deposition device 190 may be configured to target a point at which to deposit material 171 in a frame of reference 101b and apply material 171 independently or substantially independently of forces or displacements applied against base delivery unit 102 in a frame of reference 101a, as well as with any component. Some components include interstitial linkage members 121a, 121b, 121c, 121d, and 121c.

In one example, material deposition device 190 may be implemented as a “tethered drone” (as at least a portion of an end effector) with sensors, self-positioning logic, material delivery modification logic and hardware (including mechanisms to implement in-line or localized pumping, mixing, and depositing), and any other logic or mechanism to maintain targeting of a point at which to deposit material 171. In an exemplary system depicted in diagram 100, base delivery unit 102 and material deposition device 190 may be configured to deposit material 171 substantially independent of elevation or grade of base delivery unit 102 in contact with a base 110 relative a base reference 191 (e.g., as a reference line or plane). In some examples, material deposition device 190 may be configured to be oriented or positioned positively or negatively 50 feet (or more) in a Z-axis relative to base reference 191, whereby positive positions in a Z-axis (e.g., “above grade”) may provide for multiple stories above base reference 191 and negative positions in a Z-axis (e.g., “below grade”) may provide for structures under base 110 (e.g., to form basements or other subterranean structures). Further, material deposition device 190 may be configured to be positioned in any radial direction relative to base delivery unit 102 to perform “radial” 3D printing of material, at least in some examples.

Material deposition device 190 is shown to be coupled to a base delivery unit 102 via one or more linkage members, such as linkage members 121a, 121b, 121c, 121d, and 121e, according at least one example. Linkage members 121a, 121b, 121c, 121d, and 121e may be coupled via joint members 122a, 122b, 122c, 122d, as well any other joint member (e.g., a rotatable joint or “wrist” joint configured to add one or more degrees of freedom to positioning material deposition device 190). An example of a joint member may include a mechanical or physical element configured to provide load-bearing capabilities during translations or spatial displacements of linkage members with which a joint member is coupled. Further, a joint member may be associated with one or more actuators with which to articulate linkage member (e.g., telescopically or otherwise), whereby examples of actuators may include hydraulic actuators, pneumatic actuators, electromechanical actuators, or any other suitable actuator.

Any of linkage members 121a, 121b, 121c, 121d, and 121e may be constructed as components suitable as a load-bearing crane system, such as systems identified as boom cranes, knuckle boom cranes, “marine” loading arm cranes, or any equivalents thereof. In at least some examples, a system of linkage members may be configured to bear loads or masses (e.g., weights) of one or more material conduits 123 and material deposition device 190. A system of linkage members shown in diagram 100 may be further configured to orient and spatially position material deposition device 190 in a first frame of reference 101b so as to deposit material 171 via nozzle unit 161 with targeted accuracies, for example, in a range of 800 mm (e.g., a size of a U.S. basketball) to less than 1 mm, or any of range of targeted positions of material deposition.

In various examples, material deposition device 190 may be configured to discharge or deposit any type of material including and not limited to any type of cementitious material of programmable viscosity. Examples of cementitious materials may include any combination of Portland cement, binder materials, admixture materials, and optionally other base materials including water (or any other liquid). Base materials may be formed from and include limestone, clay, shells, silica sand, lime, gravel, mineral particulate, or any other material including any type of regolith associated with any celestial body, such as a moon, an asteroid, or any source of soil or particulate. Examples of admixtures may include any combination of a liquid viscosity modifying admixture (“VMA”), a shrinkage reducing admixture, a liquid-reducing admixture (e.g., a water-reducing admixture), an air-entraining admixture, a retarding concrete admixture to set material 171 in various environmental conditions, and other types of admixtures, additives, binders, and the like to assist in deposition of discharged material 171. In some examples, material 171 may include at least a portion of Lavacrete, a proprietary material produced by ICON Technology, Inc. of Austin, Texas, or any other equivalent material. Material 171 may be supplied to material deposition device 190 via one or more material conduits 123 (e.g., tubes, pipes, etc.), whereby material deposition device 190 may be configured to mix or combine various components of a material adjacent nozzle unit 161 in some examples.

Diagram 100 further depicts a base delivery unit 102 including base spatial logic 111 that may be implemented in software or hardware (or a combination thereof) and a base delivery subsystem 112. Base delivery unit 102 may be disposed or located upon a chassis 113 or any other platform supported by, for example, one or more wheels 103 (or any other mobile structure) and one or more stabilization structures 104, such as one or more outriggers, both of which are configured to position chassis 113 relative to base 110. Base 110 may be any surface, such a graded terrain, any terrestrial surface, or supported upon with a floatable structure on a liquid or gaseous surface (e.g., such as upon on a body of water), at least in some examples. In at least one case, a floatable structure or any other structure may include a ship deck, a barge, or any type of ship or boat upon which base delivery subsystem 112 may be located. Base spatial logic 111 may include logic and/or sensors to compensate for forces associated with motion vectors 105, such as waves or swells in a lake, ocean, or any body of water, to isolate material deposition device 190 in frame of reference 101b from movements relative to frame of reference 101a. Further, base 110 may impart energy or forces that may cause displacement of based delivery unit 102 in accordance with one or more motion vectors 105. For example, vibrations or a dampened or rain-soaked soil as base 110 may cause base delivery unit 102 to change its position over time relative to its frame of reference 101a.

Base spatial logic 111 may be configured to include sensors or otherwise implement other sensor data to detect environmental conditions relative to frame of reference 101a. Examples of sensor data detected at base spatial logic 111 may include temperature, humidity, wind direction and strength, time of day, thermal energy (e.g., radiated heat or sunlight strength), external objects (e.g., persons or things), geographic location, and the like. Further, base spatial logic 111 may be configured to receive sensor data from sensors 172 that may be disposed or located in or on corresponding linkage members 121a, 121b, 121c, 121d, and 121e. Sensors 172 may include any type of sensor to generate positional data and orientation data of each of the linkage members so that base delivery unit 102 may adjust positioning of any linkage member in response, for example, to motion vectors 105 or displacement of base delivery unit 102. In some examples, sensors 172 may include inertial measurement units (“IMUs”) to identify forces, angular rate of change, accelerations, rates of speed, position data relative to frame of reference 101a, and the like. For example, sensors 172 or any other sensors in diagram 100 may be configured to kinematically identify, compute, and/or compensate for flexion or “sagging” of linkage members 121a, 121b, 121c, 121d, and 121e due to gravitational forces (e.g., gravity) or displacement by any other force, mechanism, conditions, or phenomena. In some examples, sensors 172 may include optical sensors, image sensors, light detection and range sensors (“Lidar”), acoustic sensors, ultrasonic sensors, radar, pressure sensors, gyros, and the like. Also, base spatial logic 111 may be configured to exchange sensor data 129 through any electronic communication channel (e.g., including wireless communications) with material deposition device 190 to exchange sensor data 129 describing information to identify positions and orientations of nozzle unit 161 in frame of reference 101b to adjust linkage members 121a, 121b, 121c, 121d, and 121e to maintain stability and accuracy of deposition of material 171 independent of forces that may be applied to one or more components depicted in diagram 100. Hence, base spatial logic 111 is configured to compute positioning of linkage members 121a, 121b, 121c, 121d, and 121e and generate control data for actuation of hydraulic joints 122a, 122b, 122c, and 122d to maintain a position and orientation of nozzle unit 161.

Base delivery subsystem 112 may include one or more motors or engines to control actuators associated with joints 122a to 122d to displace or move linkage members 121a, 121b, 121c, 121d, and 121e responsive to control data received from base spatial logic 111. In some cases, base delivery subsystem 112 may include pumping mechanisms to pump material 171 via material conduit 123 to nozzle unit 161. Control data generated by base delivery subsystem 112 may also be configured to control flow rate using sensors 172 of pumping material 171 as well controlling mixing of elements (e.g., cementitious material, admixtures, additives, etc.) at base delivery subsystem 112.

Further, diagram 100 depicts a material deposition device 190 that includes a stabilization platform 116, target spatial logic 117, a target delivery subsystem 118, and nozzle unit 161. Stabilization platform 116 may be configured to support or employ, target spatial logic 117, a target delivery subsystem 118, and nozzle unit 161 to discharge material 171 to form structure 173. Target spatial logic 117 may include sensors or may be configured to receive sensor data based on one or more optical sensors, image sensors, light detection and range sensors (“Lidar”), acoustic sensors, ultrasonic sensors, radar, pressure sensors, gyros, and the like to stabilize a position and orientation of nozzle unit 161. Also, target spatial logic 117 may also receive sensor data 129 in communication with base delivery unit 102 to receive information to assist in stabilizing nozzle 161. Further, target spatial logic 117 may be configured to receive spatial dimension data describing a path (e.g., a “print path”) to guide orientation and position of nozzle unit 161 to deposit material in accordance with architectural specifications. In one example, data describing a print path be implemented using Geometric Code, or “G-code,” as a programming language configured to generate control data commands to manage operation of target delivery subsystem 118, which may include any number of actuators to position nozzle unit for printing material 171 in accordance with the spatial dimension data.

In some embodiments, material deposition device 190 may be configured to deposit any material, including metal-inclusive additives or any other metallic-based material (or any material of any elemental or molecular form). For example, material deposition device 190 may be configured to facilitate deposition of metal or any “welding” of metal or other materials to deposit a material to form structure 173. While material deposition device 190 is not limited to just depositing any type of material, material deposition device 190 may be configured to implement subtractive processes as well as additive processes (or subtractive processes alone). In some examples, material deposition device 190 and/or stabilization platform 116 may be configured to perform subtractive actions to modify one or more portions of structure 173. For example, stabilization platform 116 may be configured to sand, grind, cut, mill, or otherwise subtractively remove any material deposited as a portion of structure 173. As an example, target spatial logic 117 may be configured to sense via any sensors depicted or described relative to diagram 100 (or elsewhere herein) displacements due to mechanical or other forces applied to structure 173 due to, for example, a grinding mechanical action imparting vibratory motions for which target spatial logic 117. Hence, material deposition device 190 and/or stabilization platform 116 may be configured to compensate to ensure material deposition device 190 and/or stabilization platform 116 can be stabilized in a frame of reference 101b.

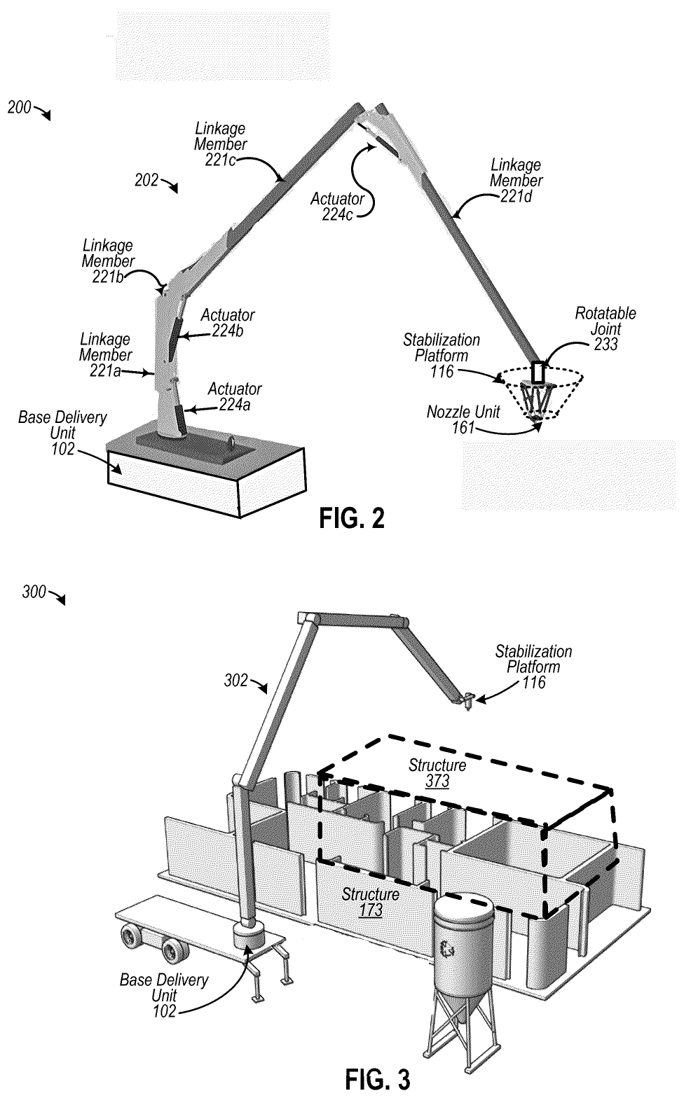

FIGS. 2 and 3 depict examples of systems implementing a stabilization platform coupled via linkage members to a base delivery unit, according to some examples. Diagram 200 of FIG. 2 includes a system 202 configured to deposit material in accordance with 3D printing construction techniques. As shown, system 202 includes base delivery unit 102 and stabilization platform 116 including a nozzle unit 161, whereby base delivery unit 102 is coupled via linkage members 221a, 221b, 221c, and 221d to nozzle unit 161. Linkage members 221a, 221b, 221c, and 221d may be coupled to each by actuators 224a, 224b, and 224c at respective joints with an optional rotatable joint 233 coupled to stabilization platform 116.

FIG. 3 includes a diagram 300 depicting another example of system 302 configured to deposit material including base delivery unit 102 and stabilization platform 116. As shown, system 302 may be configured to deposit material as bead structures or longitudinal structures to additively manufacture structure 173, which may be a wall in a first story building. Also shown, systems 302 may be configured to 3D print a second story structure 373, as an example. Other stories and structures may be also manufactured with system 302.

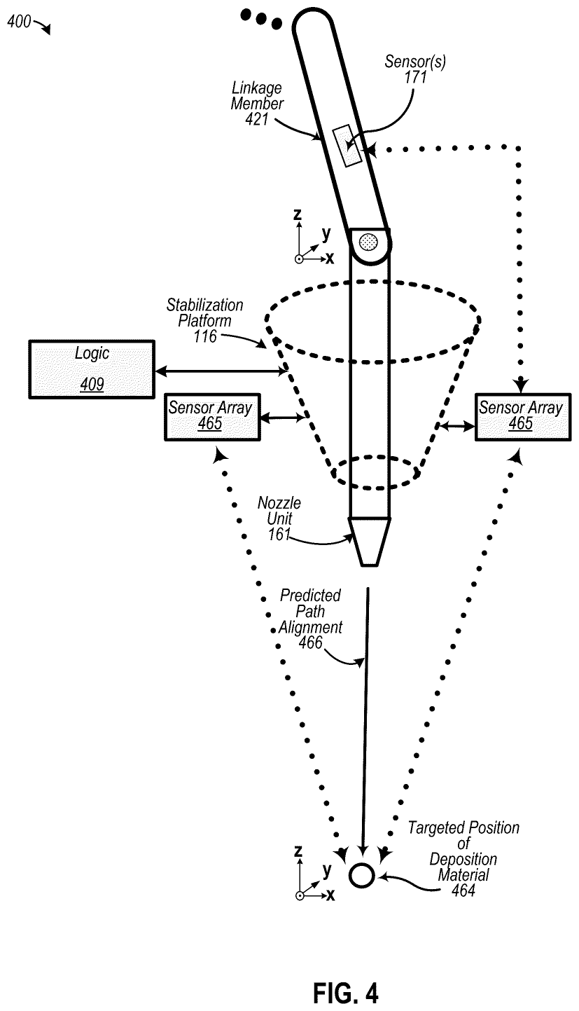

FIG. 4 is a diagram depicting another example of a stabilization platform and a nozzle unit of a material deposition device that implements one or more arrays of sensors, according to some examples. As depicted in diagram 400, stabilization platform 116 and nozzle unit 161 are coupled to a one or more linkage members 421 that includes sensors 172. Material may be transported (e.g., pumped) through or in association with linkage 421 for delivery to nozzle unit 161. Logic 409 (e.g., target spatial logic) may be configured to implement arrays of sensors 465 to detect a targeted position 464 for depositing material. Logic 409 may be further configured to control one or more actuators (not shown) in stabilization platform 116 to align nozzle unit 161 with an aligned predicted path 466 defined by a data file include spatial dimensions of an architectural building specification. In some examples, spatial dimension data may be referred to as structure formation data that may include 3D printer control data to manufacture, for example, a certain type of house.

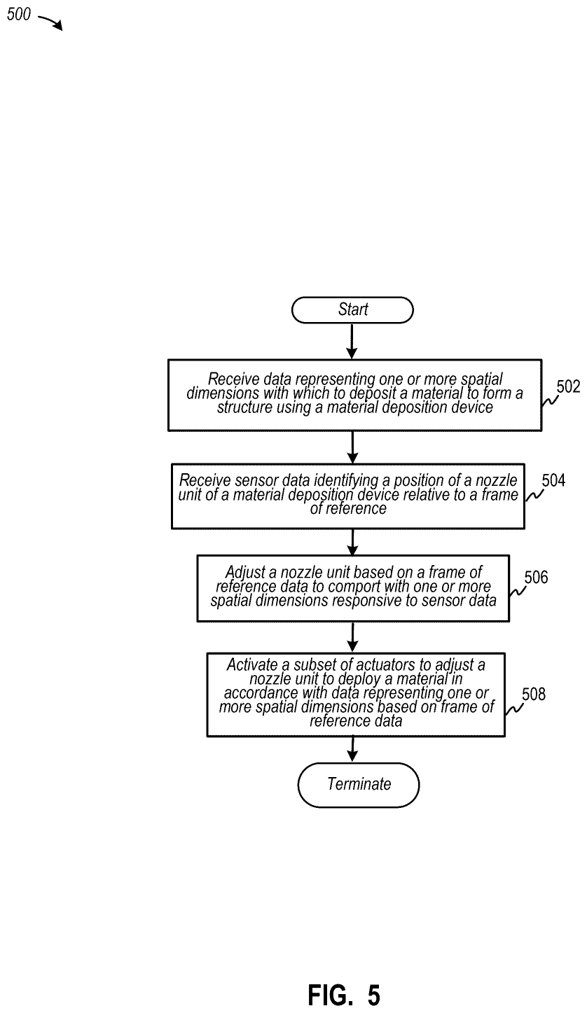

FIG. 5 depicts an example flow with which to deposit material using a material deposition device, according to some examples. At 502, flow 500 receives data representing one or more spatial dimensions with which to deposit a material to form a structure using a material deposition device. In some examples, data representing one or more spatial dimensions may include data defining a print path over which to deposit a material using, for example, a programming language (e.g., G-Code) to implement 3D printing commands. Material that is deposited may include any composition of one or more of a cementitious material, a regolith material, admixtures, binders, sand, etc.

At 504, sensor data identifying a position of a nozzle unit of a material deposition device may be received, whereby the position of the nozzle unit may be associated with a first frame of reference. Sensor data may include data representing laser-detected positioning (or any other alignment sensor) of a nozzle unit relative to a targeted position for depositing a material on a print path. Sensor data may also include acoustic data and ultrasonic data to determine positioning of the material deposition device relative to environmental objects (e.g., to avoid contacting any object). Sensor data also may include optical or image data generated by a camera (or other image capture devices) that may be coupled to the material deposition device via a gimble.

At 506, a nozzle unit position or orientation may be an adjustment based a first frame of reference to comport with one or more spatial dimensions responsive to sensor data. For example, a nozzle unit may be oriented responsive to 3D printing commands based on the sensor data to deposit a bead of a material upon, for example, other previously deposited beads to form a structure, such as a wall. In some examples, a position of a nozzle may be displaced or moved responsive to an external force, such as a gust of wind, rain, or other environmental factors. Thus, an array of sensors may be configured to detect a displacement whereby target spatial logic may be configured to compute a value or amount of displacement. Further, target spatial logic may be further configured to generate command data to adjust (e.g., re-adjust) the position of the nozzle unit to align with target position at which a bead of material is to be deposited in accordance with data representing a print path. A detected displacement may be due to one or more variances in an X-axis, a Y-axis, and a Z-axis.

At 508, a subset of actuators disposed or located in a material deposition device may be activated to adjust a nozzle unit to deploy a material in accordance with data representing print path data relative based on frame of reference data. In some examples, displacement of one or more linkage members coupled to the nozzle unit may be detected, whereby target spatial logic may be configured to compute the displacement of one or more linkage members, and may be further configured to generate command data to adjust a position of a nozzle unit to compensate for displacement of one or more linkage member. Logic in a material deposition device may receive a first subset of position data associated with a base delivery unit. The logic may receive a second subset of position data associated with one or more linkage members coupling the base delivery unit to the nozzle unit. The nozzle unit may be adjusted as a function of the first and the second subsets of the position data.

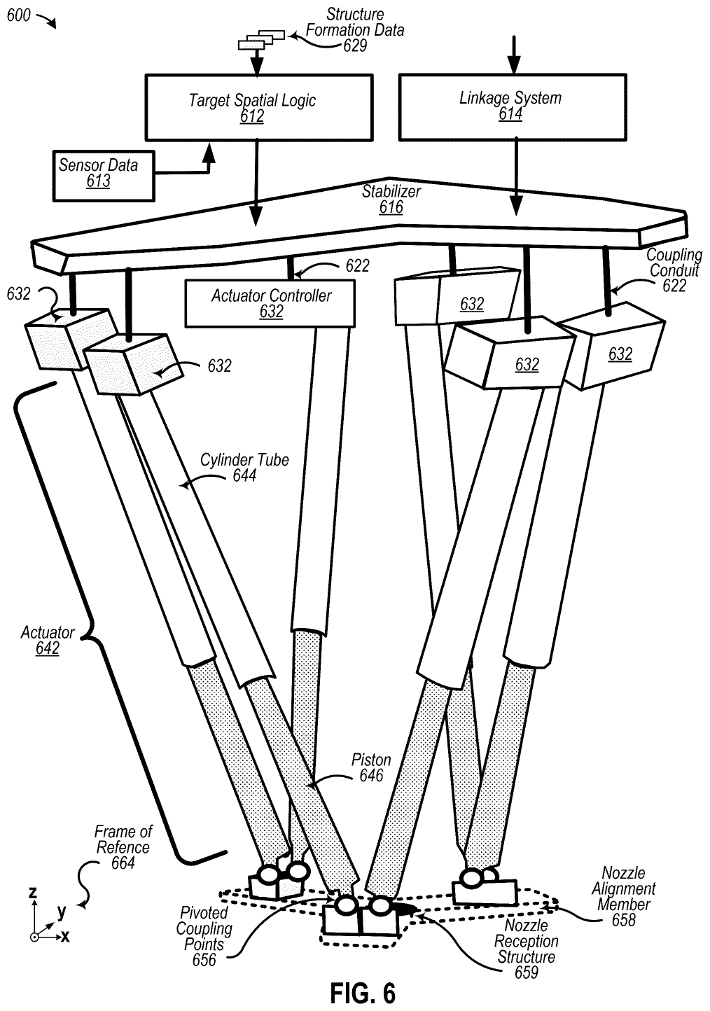

FIG. 6 depicts an example of a portion of a material deposition device, according to some embodiments. Diagram 600 includes a stabilizer 616 as a portion of a stabilized platform mechanically and electrically coupled via coupling conduits 622 to any number of subsets of actuators 642. An actuator 642 may include a cylinder tube 644 and a piston 646, whereby piston 646 may be coupled via a pivoted coupling point 656 to a nozzle alignment member 658. As shown, nozzle alignment member 658 may include a nozzle reception structure 659 configured to receive and adjust (e.g., steer) nozzle unit (not shown) in a frame of reference 664.

Diagram 600 also includes target spatial logic 612 and linkage system 614 coupled to stabilizer 616. Linkage system 614 may include portions of a linkage member and a material conduit for receiving pumped material. Target spatial logic 612 may include logic configured to receive sensor data 613 to compute a position or orientation of a nozzle unit. Target spatial logic 612 may also include logic configured to receive a data file (e.g., structure formation data 629) to identify a print path based on an architectural specification. Based on sensor data 613 and the data file, target spatial logic 612 may be further configured to activate one or more actuators 632 via coupling conduits 622 by transmitting control command data to actuator controllers 632. In response, actuators 642 are configured to modify positions of pivoted coupling points 656, thereby causing nozzle alignment member 658 to apply guiding forces to a nozzle unit.

Note that one or more components depicted in FIG. 6 may be composed of hardware or software (of a combination thereof) and may be distributed internally or externally (or a combination thereof) to a material deposition device. Further, any number of actuators may be implemented without restriction and are not limited to the amounts or configuration of diagram 600. Also, actuators 642 may include any of one or more of hydraulic actuators, pneumatic actuators, electromechanical actuators, or any other suitable actuator.

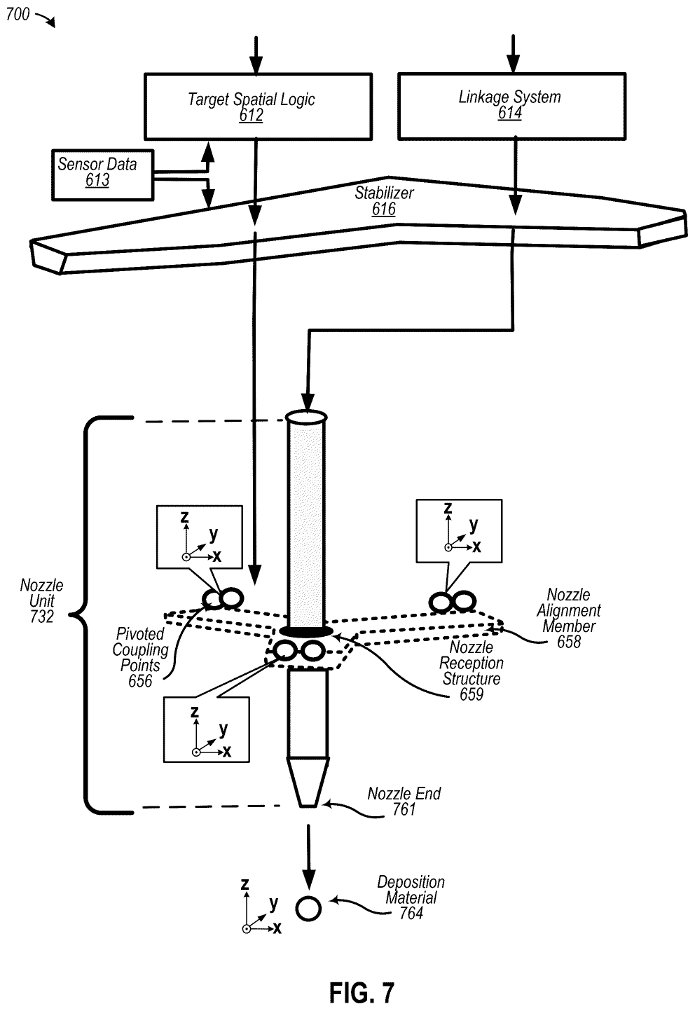

FIG. 7 is a diagram depicting an example of a portion of a material deposition device including a nozzle unit, according to some implementations. Diagram 700 includes target spatial logic 612, linkage system 614, sensor data 613 and stabilizer 616 of FIG. 6. Target spatial logic 612 is shown conceptually to control the positions of pivoting coupling points 656, and linkage system 614 is shown conceptually to provide or pump material to nozzle unit 732. Diagram 700 also depicts pivoted coupling points 656, nozzle reception structure 659, and a nozzle alignment member 658 of FIG. 6. Referring back to FIG. 7, a nozzle unit 732 is shown to be located through nozzle reception structure 659 whereby nozzle end 761 is configured to deposit material 764 at a targeted location, Material 764 may be in the form of a bead or in any other form.

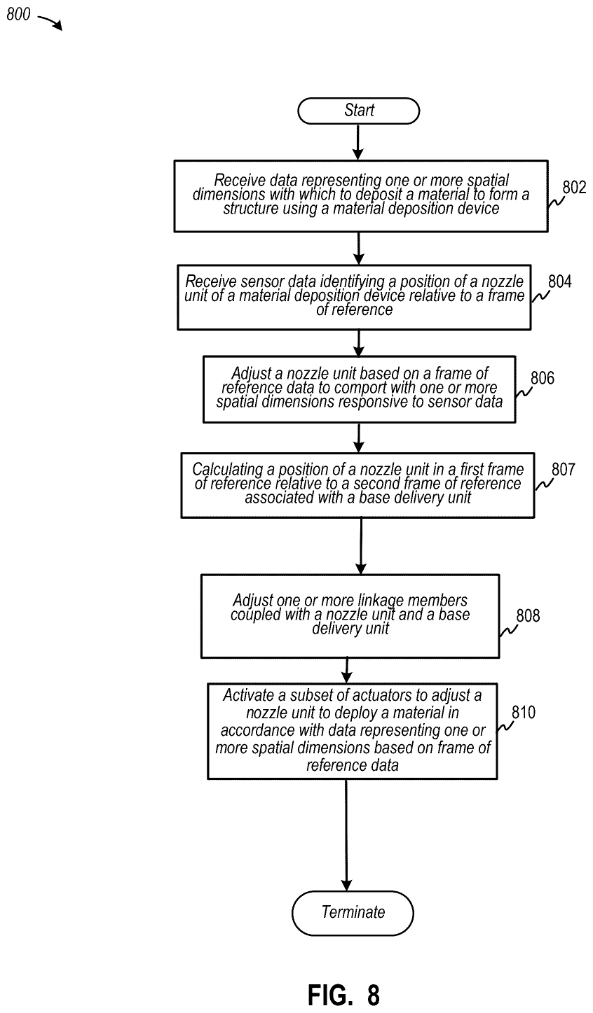

FIG. 8 depicts an example flow with which to deposit material by

adjusting a nozzle unit, according to some examples. Flow 800 initiates at 802, at which data representing one or more spatial dimensions with which to deposit a material to form a structure may be received at a material deposition device. At 804, sensor data identifying a position of a nozzle unit may be received into a material deposition device, whereby a position of a nozzle unit may be relative to a first frame of reference. At 806, a nozzle unit may be adjusted based on a frame of reference data to comport with one or more spatial dimensions defining a print path location relative to the nozzle unit. At 807, a position of a nozzle unit may be computed in a first frame of reference relative to a second frame of reference associated with a base delivery unit. At 808, one or more linkage members may be adjusted, the one or more link members being coupled between a nozzle unit and a base delivery unit to stabilize a nozzle unit. At 810, a subset of actuators may be activated (e.g., within a material deposition device) to adjust a nozzle unit to deploy a material in accordance with data representing one or more spatial dimensions of a print path relative to the first frame of reference.

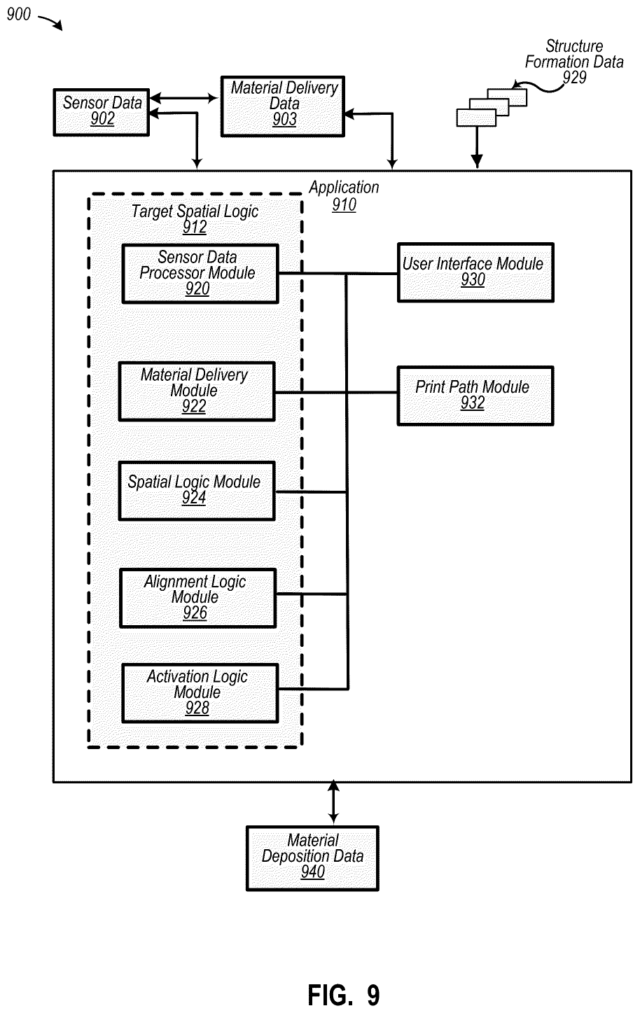

FIG. 9 illustrates an exemplary application architecture for temporal position detection and adjustment control for a nozzle unit to deposit or extrude one or more materials to manufacture a structure, according to some examples. Diagram 900 is shown to include an application 910 including modules configured to provide functionalities base on sensor data 902, structure formation data 929 (e.g., data identifying a position or orientation of a print path), and material delivery data 903 configured to control delivery of a material through a nozzle unit, as well as any other data. Application 900 may be structured to generate material deposition 940 to control a nozzle by, for example, including 3D print commands or any other executable instruction to activate one or more actuators of a material disposition device. Structurally, in some examples, application 910, and the elements shown and described may be implemented as hardware, software, firmware, logic-specific circuitry, or as a combination thereof, without restriction or limitation to any particular implementation environment, 3D printing manufacturing process (or any other suitable manufacturing process), or configuration to form structure like shelters, houses, buildings, roads, aircraft hangers, factory buildings, etc. Modules implemented in application 910 with substantially similarly reference numbers may function to the other like-numbered elements shown and described herein including FIG. 1 and any other figure.

As shown in diagram 900, application 910 may include target spatial logic 912, which may include a sensor data processor module 920, a material delivery module 922, a spatial logic module 924, an alignment logic module 926, and activation logic module 928, among others. Sensor data processor module 920 may be configured to receive a variety of subsets of sensor data 902 from any number of sensors to detect or compute a position and an orientation of one or more of a nozzle unit, a stabilization platform, and a material deposition device relative to a frame of reference. Material delivery module 922 may receive material delivery data at 903 and may be configured to monitor, implement, adjust, or otherwise control material flow as it is received into a nozzle unit or into a material deposition device. Spatial logic module 924 may be configured to receive sensor data 902 and structure formation data 929, as well as any other data, to determine spatial dimensions of a print path associated with a surface (or other previously formed beads of material). Alignment logic module 924 may be configured to predict an alignment path over which nozzle unit traverses to maintain accuracy and precision of the deposition of material. Activation logic module 928 may be configured to interact with other modules to determine and control activation of one or more actuators to control position of a nozzle. In some cases, material deposition data 940 may be generated by activation logic module 928 or by any module in application 910. Note that each of the modules of application 910 may interact electronically with each other to correlate and/or combine functionalities to provide for material deposition. Further, any module may communicate internally or externally with other applications or other computing platforms via, for example, an application programming interface (“API”).

User interface module 930 may be configured to exchange data with any number of user interfaces for presenting activity data and for receiving instructions to view and modify functionalities of a material deposition device or any other portion of a manufacturing system. Print path module 932 may be configured to identify a print path and monitor the progress of the depositing of material to ensure conformance with manufacturing specifications and whether predicted application of actuators to move a nozzle unit is within operating parameters. Non-conformance issues may be captured as data and transmitted via user interface module 930 to assist in trouble-shooting.

Any of the described modules of FIG. 9 or any other processes described herein in relation to other figures may be implemented as software, hardware, firmware, circuitry, or a combination thereof firmware, logic-specific circuitry, or as a combination thereof, without restriction or limitation. Any of modules of FIG. 9 may be disposed, placed, distributed, or arranged in a material deposition device, or any module may be distributed at other portions of a system other than in a material deposition device.

If implemented as software, the described techniques may be implemented using various types of programming, development, scripting, or formatting languages, frameworks, syntax, applications, protocols, objects, or techniques, including, but not limited to, “G-Code,” Python™, ASP, ASP.net, .Net framework, Ruby, Ruby on Rails, C, Objective C, C++, C #, Adobe® Integrated Runtime™ (Adobe® AIR™), ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by ICON Technology, Inc., or the like. The above-described techniques may be varied and are not limited to the embodiments, examples, or descriptions provided.

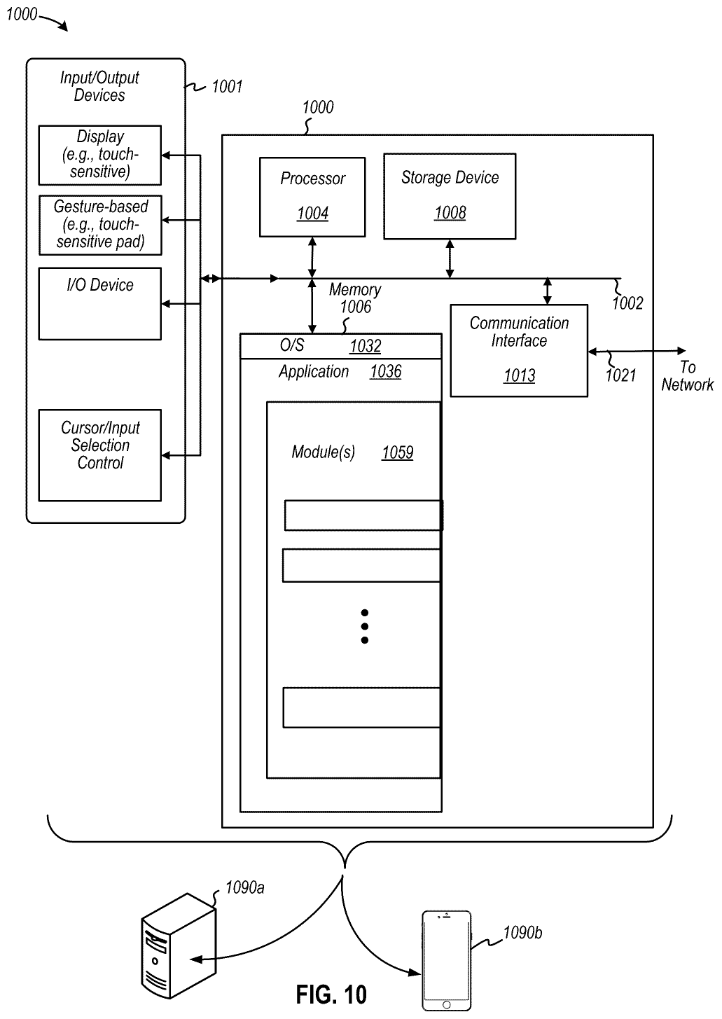

FIG. 10 illustrates examples of various computing platforms configured to provide various functionalities to components of a computing platform 1000 configured to provide functionalities described herein. Computing platform 1000 may be used to implement computer programs, applications, methods, processes, algorithms, or other software, as well as any hardware implementation thereof, to perform the above-described techniques.

In some cases, computing platform 1000 or any portion (e.g., any structural or functional portion) can be disposed or located in any device, such as a computing device 1090a, mobile computing device 1090b, and/or a processing circuit in association with initiating any of the functionalities described herein, via user interfaces and user interface elements, according to various examples.

Computing platform 1000 includes a bus 1002 or other communication mechanism for communicating information, which interconnects subsystems and devices, such as processor 1004, system memory 1006 (e.g., RAM, etc.), storage device 1008 (e.g., ROM, etc.), an in-memory cache (which may be implemented in RAM 1006 or other portions of computing platform 1000), a communication interface 1013 (e.g., an Ethernet or wireless controller, a Bluetooth controller, NFC logic, etc.) to facilitate communications via a port on communication link 1021 to communicate, for example, with a computing device, including mobile computing and/or communication devices with processors, including database devices (e.g., storage devices configured to store relational data, structured data, unstructured data, and graph data or atomized datasets, including, but not limited to triple stores, etc.). Processor 1004 can be implemented as one or more graphics processing units (“GPUs”), as one or more central processing units (“CPUs”), such as those manufactured by Intel® Corporation, or as one or more virtual processors, as well as any combination of CPUs and virtual processors. Or, a processor may include a Tensor

Processing Unit (“TPU”), or equivalent. Computing platform 1000 exchanges data representing inputs and outputs via input-and-output devices 1001, including, but not limited to, keyboards, mice, audio inputs (e.g., speech-to-text driven devices), user interfaces, displays, monitors, cursors, touch-sensitive displays, touch-sensitive inputs and outputs (e.g., touch pads), LCD or LED displays, and other I/O-related devices.

Note that in some examples, input-and-output devices 1001 may be implemented as, or otherwise substituted with, a user interface in a computing device associated with, for example, a user account identifier in accordance with the various examples described herein.

According to some examples, computing platform 1000 performs specific operations by processor 1004 executing one or more sequences of one or more instructions stored in system memory 1006, and computing platform 1000 can be implemented in a client-server arrangement, peer-to-peer arrangement, or as any mobile computing device, including smart phones and the like. Such instructions or data may be read into system memory 1006 from another computer readable medium, such as storage device 1008. In some examples, hard-wired circuitry may be used in place of or in combination with software instructions for implementation. Instructions may be embedded in software or firmware. The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks and the like. Volatile media includes dynamic memory, such as system memory 1006.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding, or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by computing platform 1000. According to some examples, computing platform 1500 can be coupled by communication link 1021 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 1000 may transmit and receive messages, data, and instructions, including program code (e.g., application code) through communication link 1021 and communication interface 1013. Received program code may be executed by processor 1004 as it is received, and/or stored in memory 1006 or other non-volatile storage for later execution.

In the example shown, system memory 1006 can include various modules that include executable instructions to implement functionalities described herein. System memory 1006 may include an operating system (“O/S”) 1032, as well as an application 1036 and/or logic module(s) 1059. In the example shown in FIG. 10, system memory 1006 may include any number of modules 1059, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. These can be varied and are not limited to the examples or descriptions provided.

In some embodiments, modules 1059 of FIG. 10, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 1059 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 1059 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, modules 1059 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including several components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
receiving data representing one or more spatial dimensions with which to deposit a material to form a structure using a material deposition device;
receiving sensor data identifying a subset of spatial data points representing a position of a nozzle unit of the material deposition device, the sensor data configured to identify frame of reference data associated with the nozzle unit based on the subset of spatial data points;
adjusting the nozzle unit based on the frame of reference data to comport with the one or more spatial dimensions responsive to the sensor data; and
activating a subset of actuators to adjust the nozzle unit to deploy the material in accordance with the data representing the one or more spatial dimensions based on the frame of reference data.

2. The method of claim 1 wherein at least a portion of the material comprises one or more cementitious materials.

3. The method of claim 1 wherein at least a portion of the material comprises a regolith material.

4. The method of claim 1 wherein activating the subset of actuators to adjust the nozzle unit further comprises:
deploying the material as a bead of the material upon which other beads of the material are deposited to form a structure.

5. The method of claim 1 further comprising:
detecting a displacement of the position of the nozzle unit;
computing the displacement; and
adjusting the position of the nozzle unit spatially to compensate for the displacement to align with the data representing the one or more spatial dimensions.

6. The method of claim 1 wherein adjusting the nozzle unit based on the frame of reference data comprises:
detecting a displacement of the position of the nozzle unit relative to one or more variances in an X-axis, a Y-axis, and a Z-axis.

7. The method of claim 1 further comprising:
detecting displacement of one or more linkage members coupled to the nozzle unit;
computing the displacement of the one or more linkage members; and
adjusting the position of the nozzle unit to compensate for the displacement of the one or more linkage members to align the nozzle unit in accordance with the data representing the one or more spatial dimensions.

8. The method of claim 1 further comprising:
receiving the material from a base delivery unit,
wherein the base delivery unit includes a subset of sensors to compute a position in another frame of reference and to compute spatial displacements relative to the nozzle unit.

9. The method of claim 1 wherein adjusting the nozzle unit based on the frame of reference data comprises:
receiving a first subset of position data associated with a base delivery unit;
receiving a second subset of position data associated with one or more linkage members coupling the base delivery unit to the nozzle unit; and
adjusting the nozzle unit as a function of the first and the second subsets of the position data.

10. The method of claim 1 wherein receiving the data representing the one or more spatial dimensions comprises:
receiving a data file including data identifying a print path over which the nozzle unit deposits the material.

11. A system comprising:
a memory including executable instructions; and
a processor, responsive to executing the instructions, is configured to:
receive data representing one or more spatial dimensions with which to deposit a material to form a structure using a material deposition device;
receive sensor data identifying a subset of spatial data points representing a position of a nozzle unit of the material deposition device, the sensor data configured to identify frame of reference data associated with the nozzle unit based on the subset of spatial data points;
adjust the nozzle unit based on the frame of reference data to comport with the one or more spatial dimensions responsive to the sensor data; and
activate a subset of actuators to adjust the nozzle unit to deploy the material in accordance with the data representing the one or more spatial dimensions based on the frame of reference data.

12. The system of claim 11 wherein at least a portion of the material comprises one or more cementitious materials, at least a portion including a regolith material.

13. The system of claim 11 further comprising a printer head tool configured to identify a target deposition point and to adjust the position of the nozzle unit.

14. The system of claim 11 wherein the processor is configured to activate the subset of actuators to adjust the nozzle unit is further configured to:
deploy the material as a bead of the material upon which other beads of the material are deposited to form a structure.

15. The system of claim 11 wherein the processor is configured to:
detect a displacement of the position of the nozzle unit;
compute the displacement; and
adjust the position of the nozzle unit spatially to compensate for the displacement to align with the data representing the one or more spatial dimensions.

16. The system of claim 11 wherein the processor is configured to adjust the nozzle unit based on the frame of reference data is further configured to:
detect a displacement of the position of the nozzle unit relative to one or more variances in an X-axis, a Y-axis, and a Z-axis.

17. The system of claim 11 wherein the processor is further configured to:
detect displacement of one or more linkage members coupled to the nozzle unit;
compute the displacement of the one or more linkage members; and
adjust the position of the nozzle unit to compensate for the displacement of the one or more linkage members to align the nozzle unit in accordance with the data representing the one or more spatial dimensions.

18. The system of claim 11 wherein the processor configured to adjust the nozzle unit based on the frame of reference data is further configured to:
receive a first subset of position data associated with a base delivery unit;
receive a second subset of position data associated with one or more linkage members coupling the base delivery unit to the nozzle unit; and
adjust the nozzle unit as a function of the first and the second subsets of the position data. 19 A computer-readable recording medium storing instructions configured to receive data requesting to execute instructions in association with a processor, a method comprising:
receiving data representing one or more spatial dimensions with which to deposit a material to form a structure using a material deposition device;
receiving sensor data identifying a subset of spatial data points representing a position of a nozzle unit of the material deposition device, the sensor data configured to identify frame of reference data associated with the nozzle unit based on the subset of spatial data points;
adjusting the nozzle unit based on the frame of reference data to comport with the one or more spatial dimensions responsive to the sensor data; and
activating a subset of actuators to adjust the nozzle unit to deploy the material in accordance with the data representing the one or more spatial dimensions based on the frame of reference data.
